(19) United States
(12) Patent Application Publication
(10) Pub. No.: US 2011/0158649 A1
(43) Pub. Date: Jun. 30, 2011

(54) INTEGRATING PLURALITY OF BUILDING MANAGEMENT SERVICES AND HOME AUTOMATION SERVICES WITH PLURALITY OF MULTI - PLAY SERVICES ON NEUTRAL ACCESS NETWORK OPERATIONS BASIS

(76) Inventor: Shanker Singh Hari, Noida (IN)

(21) Appl. No.: 13/059,979

(22) PCT Filed: Aug. 31, 2009
(86) PCT No.: PCT/IN09/00475

§ 371 Date: Feb. 20, 2011

(30) Foreign Application Priority Data
Aug. 29, 2008 (IN) 2046/DEL/2008

(51) Int. Cl. H04J 14/00; H04J 14/02; H04J 14/08

(52) U.S. Cl. 398/66

(57) ABSTRACT

A multi play single fiber system is described. The system comprises a single fibre for provisioning one or more of Global System of Mobile (GSM) Communication, Code Division Multiple Access (CDMA), Worldwide Interoperability for Microwave Access (Wimax), Global Positioning System (GPS) based services implemented on one or more of: Asynchronous Transfer Mode (ATM), Time-Division Multiplexing (TDM), Transmission Control Protocol-Internet Protocol (TCP-IP), Radio Frequency (RF), Wavelength Division Multiplexing (WDM) or Dense Wavelength Division Multiplexing (SWDM) and a hardware coupled computer programmable device coupled with the single fiber to create plurality of tunnels within the said single fiber and create plurality of circuits within the said tunnels.

### RELATED APPLICATIONS

This application is a 35 U.S.C. §371 National Stage of PCT/IN2009/000475 filed Aug. 31, 2009 (published as WO2010/035280 on Apr. 1, 2010), which claims priority to 2046/DEL/2008 (India, “IN”), filed Aug. 29, 2008. All of the foregoing applications and publications thereof are incorporated herein by reference.

### FIELD OF INVENTION

This invention generally relates to infrastructure management services, where users have interest in plurality of services provide by plurality of distinct service providers Particularly, the invention is related to enabling use of single fiber for securely providing distinct multiple services to an end consumer or user.

### BACKGROUND OF THE INVENTION

This invention relates to estate related (including residential, commercial, educational, governmental and mixed usage) building management services in particular and similar services for other applications, where users have interest into varied services. The services needed by users are broadly of three types.

One is the service extended by outside service-providers like basic telephony, high speed internet, broadcast television, and on-demand multimedia contents. There are various competing service-providers having their own unique sales proposition to meet the specific need of users. Not only this, due to spread of broadband, various essential services are getting popular like telemedicine, distance education, video chatting, social networking, e-newspaper, e-mails, data sharing and personal websites etc.

Another type of services are in-building services ranging from community surveillance system, community security system, access control system, visitor/guest identification system, vehicle management system, emergency announcement system, public address system, automated utility meters reading and control systems etc.

Apart from the services as mentioned above, there is a growing demand of remote home automation, remote home control, remote home monitoring and activation and deactivation of various gadgets inside the home environment inter-alia.

Separate infrastructure for carrying Building Management Services (BMS) including CCTV (Closed Circuit Television), HVAC (Heat, Ventilation and Air Conditioning), Access control, automated utility meters reading and control systems inter-alia and separate infrastructure for last-mile connectivity for carrying Information Communication Technology (ICT) services (dedicated or shared) entails heavy expenditure—capital as well as recurring, by the Service-Providers and Property Owner/Developer.

Further, use of remote monitoring and control applications (Enabled Home in case of a residential use and plethora of applications for commercial and miscellaneous application) entails more investment by the end-user. Increasingly growing requirement of broadband, bandwidth and value added services coupled with the ever-increasing requirements of new-age tech-savvy digital native, a solution is desirable for convergence of all services whether ICT services, building management services or relating to enabled home at the cheapest possible cost.

FIG. 1 depicts the typical multiple infrastructure, presently followed to meet the requirement of services by the end-users. This seriously lacks in accommodating any future services. Furthermore, the conventional infrastructure is prone to degradation, multiple failure and low availability in terms of uptime. Also, the typical service infrastructure layout restricts the choice of end-users regarding the future services and service-providers as prediction of future technology and service-provider cannot be anticipated at the time of development or construction of such infrastructure.

Also, it is impractical as well as impossible to predict the future of technology. Also, such multiple infrastructures involves huge sum of money by each service provider by way of capital expenditure and recurring expenditure. Such investment by multiple service providers in multiple parallel infrastructures is recovered from users of such services, thereby making the usage charges to the customer very high, thus making the entire proposition between the service provider and end-users un-economical.

### SUMMARY OF THE INVENTION

This Invention relates to Method and System for Integrating Plurality of Building Management Services & and Home Automation Services and other services including Multi-Play Services of plurality of carriers' communication services (wire line and wireless) including Voice, Video and Data on Active and/or Passive Optical Network and/or Copper Network for Neutral Access Network Operations.

In the light of the above described problems and shortcomings as well as others, various exemplary embodiments according to this invention provide (1) Method and system for providing Multi-play Services (2) Provisioning of broadband services, high-speed Internet access and television, telephone, wireless communication and such like communication services) of multiple service-providers (whether wireline or (3) wireless, using one or more of GSM-Global System of Mobile Communication, CDMA-Code Division Multiple Access, Wimax-Worldwide Interoperability for Microwave Access, GPS-Global Positioning System etc.)—whether based on (4) ATM (Asynchronous Transfer Mode), TDM (Time-Division Multiplexing), TCP-IP (Transmission Control Protocol-Internet Protocol), RF Overlay (Radio Frequency Overlay), WDM (Wavelength Division Multiplexing) or DWDM (Dense Wavelength Division Multiplexing) using multiple wavelengths of light on a single fiber, Ethernet and such like, using xPON (any enabling Technology for Passive Optical Network such as APON, BPON, GPON, EPON, GEPON) technology and/or RF (Radio Frequency) technology or any combination of one or more of them, on a single point-to-multipoint optical fiber network system on shared-use basis; and (5) shared use of the same optical fiber network system for carrying to-and-fro data and signals—whether TCP-IP, Ethernet, RF Overlay and such like, intended generally for use in Building Management Systems including Surveillance Systems, CCTV, HVAC, Access Control, automated utility meters reading and control systems, automated utility meters reading and control systems inter-alia; and (θ) synergising remote monitoring and control applications, used generally for enabled/smart/connected home services and value added services using any one or more of GSM, CDMA, Wimax, GPS, Femtocell (Access Point Base Station), Zigbee etc. with the same Optical Fiber network through the ONU (Optical Network Unit) based on TCP-IP, Ethernet, RF Overlay protocols and such like.

In another embodiment, a community based communication system for providing plurality of services rendered by plurality of service providers to plurality of occupants of the community is described. The system comprises an aggregator to aggregate the plurality of services from the plurality of services providers, a splitter to distribute the plurality of services for the plurality of occupants and an optical fiber connecting the aggregator to the splitter wherein the optical fiber receives the plurality of services from the aggregator and transmits them to the splitter through multiple inbuilt service provider specific secure tunnels. The transmission is done in such manner that each of the plurality of service providers has a dedicated secure tunnel for rendering the plurality of services and is unaware of existence of other secure tunnels dedicated to other of the services providers. The dedicated secure tunnels associated with each of the plurality of service providers is configured to have multiple circuits for transmitting the plurality of services to their corresponding plurality of occupants.

In yet another embodiment, a service delivery port implemented at plurality of end users. The fiber originating from the aggregation equipment and terminating at the service delivery port is configured to create plurality of secured mediums such that each of the secured medium is connected to at least one of the delivery port for to and from transport of the plurality of services provided by at least one of the plurality of service providers. Also, each of the secured medium is such programmed that each of the service provider is capable to manage, configure and administer their respective services independently of other service providers.

### BRIEF DESCRIPTION OF THE DRAWINGS

A more complete understanding of the various embodiments of the invention may be had by references to the following detailed description when taken in conjunction with the accompanying drawings wherein:

FIG. 1 is a simplified schematic diagram of a Conventional Multiple Infrastructure for Service Delivery.

FIG. 2 is another simplified schematic diagram of an improvement over the conventional infrastructure for integrated building infrastructure for a Neutral Access Network

FIG. 3 is yet another simplified schematic diagram of Aggregation Equipment.

FIG. 4 is a simplified block diagram of a Neutral Access Network for IP based Services with a first sequence.

FIG. 5 is a simplified block diagram of a Neutral Access Network for IP based Services with a second sequence.

FIG. 6 is a simplified block diagram of a Neutral Access Network for IP based Services with a third sequence.

FIG. 7 is a simplified block diagram of a Neutral Access Network for IP based Services with a fourth sequence.

FIG. 8 is a simplified block diagram of a Neutral Access Network for IP based Services with a fifth sequence.

FIG. 9 is a simplified block diagram of a Neutral Access Network for IP based Services with a sixth sequence.

FIG. 10 is a simplified block diagram of a Neutral Access Network for IP based Services with a seventh sequence.

FIG. 11 is a simplified block diagram of a Neutral Access Network for IP based Services with an eighth sequence.

FIG. 12 is a block diagram of a Neutral Access Network for RF based DTH/HITS/CATV Services—Sequence 1

FIG. 13 is a block diagram of a Neutral Access Network for RF based DTH/HITS/CATV Services—Sequence 2

FIG. 14 is a block diagram of a Neutral Access Network for GSM/CDMA/Mobile Services through a Distributed Antenna System

FIG. 15 is a block diagram of a Femtocell based System in a Building Solution

FIG. 16 is an exemplary diagram of the preferred embodiment of the invention.

### DESCRIPTION OF THE INVENTION WITH ACCOMPANYING DRAWINGS

The methods and systems of embodiments of the present invention provide successive coupling of VLAN (Virtual Local Area Network)/VCs (Virtual Circuits)/PVC (Permanent Virtual Circuits)/PW (Pseudo Wire) in various OSI (Open Systems Interconnection) layers connecting to an Optical Line Termination Unit (OLT) on the one end by dedicating a logical layer link as input and successive configuration of outputs of Optical Network Unit (ONU) for each service provider or the Property Owner, as the case may be and then a second logical layer dedicating another logical link on the first layer for each kind of service by a service provider or the property owner and so on and so forth till the successive differentiation is achieved in terms of delivery of service contents whether voice and/or video and/or data while maintaining Quality of Service (QOS) for the intended class of services.

On dedicating a pair of wavelength for the IP packet based Voice, Video and Data services originating from OLT as mentioned above, the methods and systems of embodiments of the present invention also provide successive coupling of RF signals of different services and service providers on WDM coupler on separate wavelengths to be carried on a single fiber and successively decoupling and converting it back to the desired service(S) or service providers RF signal at the output port of the ONU by sending a command instruction for the intended ONU by the use of the EMS software communicating with aggregation equipment in the control room.

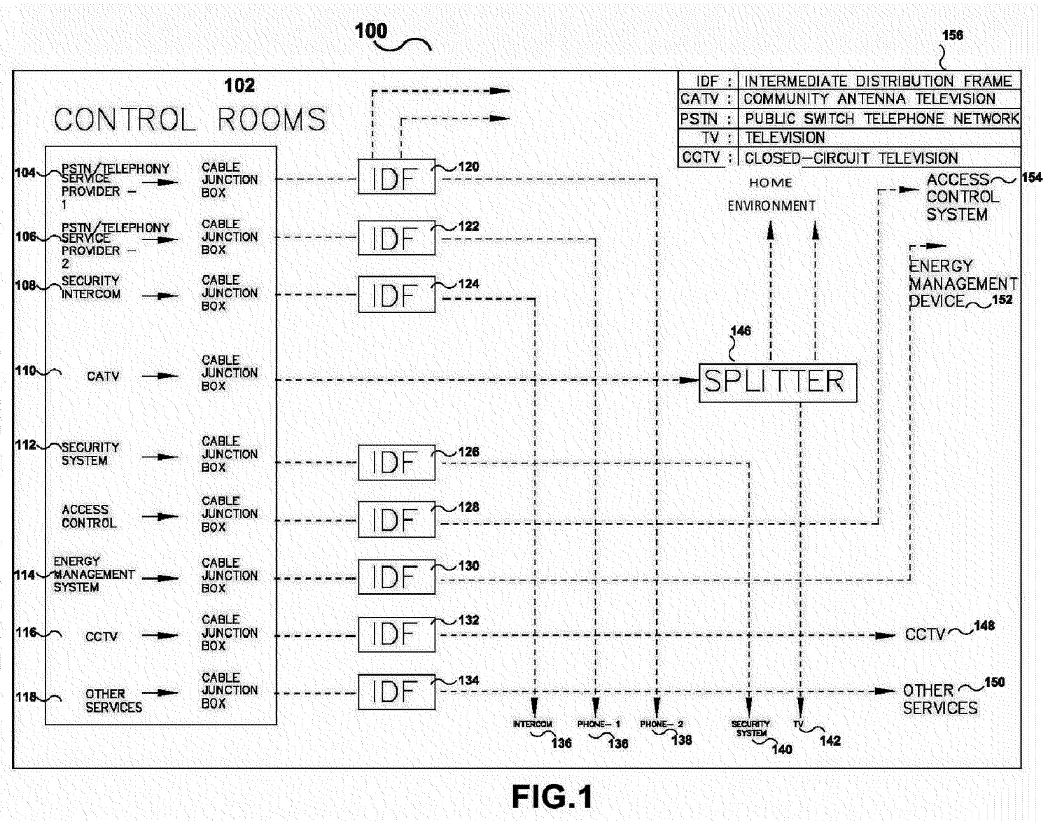

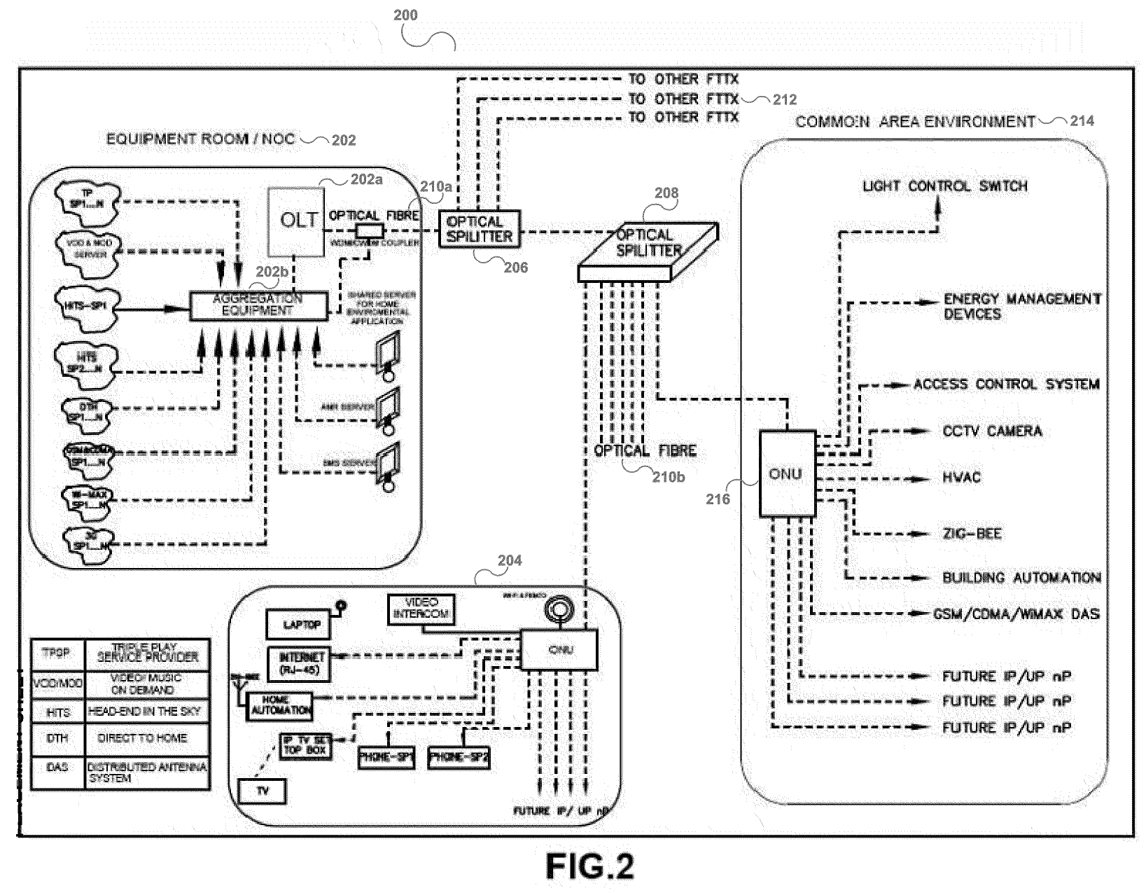

Referring to FIG. 2, there is illustrated yet another simplified schematic diagram of an improvement over the conventional infrastructure for integrated building infrastructure for Neutral Access Network. The system 200, eliminates typical shortcomings and problems being faced in the conventional scenario as described in FIG. 1. Inputs feed of all the plurality of service providers 104, 106, 108, 110, 112, 114, 116, 118 providing varied services like intercom 136, phones 138 and 140, security systems 142, television 144, CCTV 148 are terminated at Equipment Room 202. The equipment room 202 consists of an OLT 202a and Aggregator 202b. In other words, it may be understood that the fiber or any other communication mean (wireless or wireline) of multiple Service Providers 104, 106, 108, 110, 112, 114, 116, 118 terminates at the Aggregator 202b in the Equipment Room 202. The Aggregator 202b is connected through a single lit fiber carrying the plurality of services like intercom 136, phones 138 and 140, security systems 142, television 144, CCTV 148 by multiple Service providers 104, 106, 108, 110, 112, 114,116, 118 over a single fiber optic media 210a and 210b. This single fiber optic media 210a and 210b reaches each ONU 216 through an optical splitter 206 and 208 for the distribution purpose as depicted at 214.

Further, on dedicating a pair of wavelength for the IP packet based Voice, Video and Data services originating from OLT the present invention also provides successively coupling RF signals of different services and service providers on (C/D)WDM coupler on separate wavelengths to be carried on a single fiber and successively decoupling and convert it back to the desired service (S) or service providers RF signal at the output port of the ONU by sending a command instruction for the intended ONU by the use of the EMS software communicating with aggregation equipment in the control room.

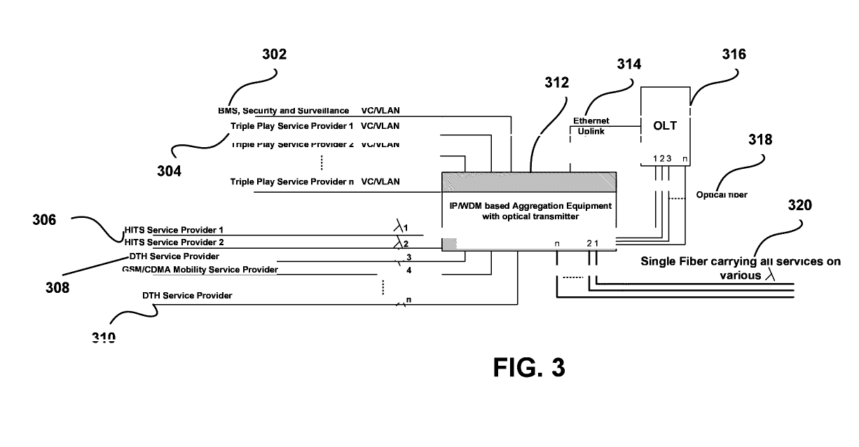

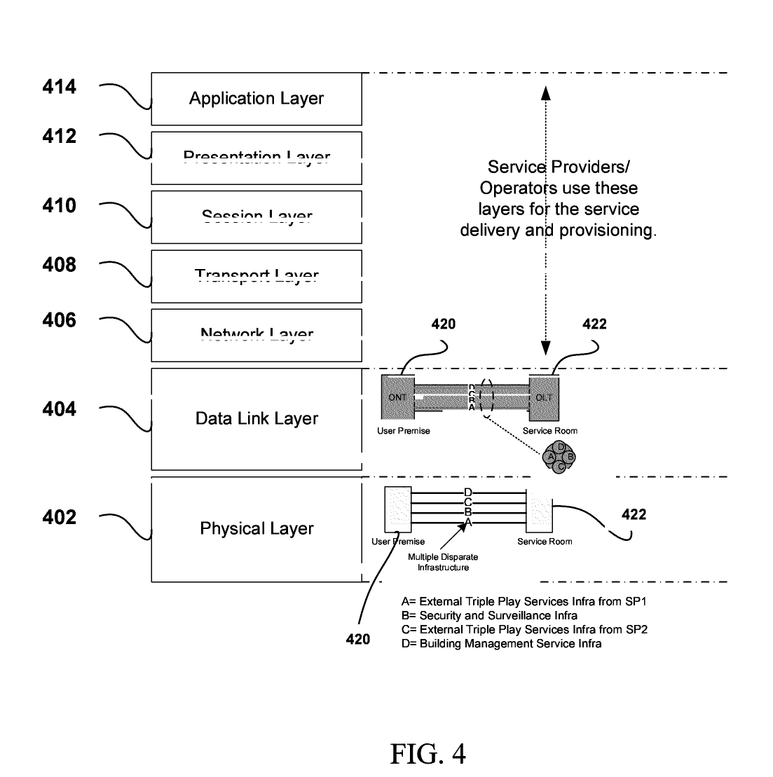

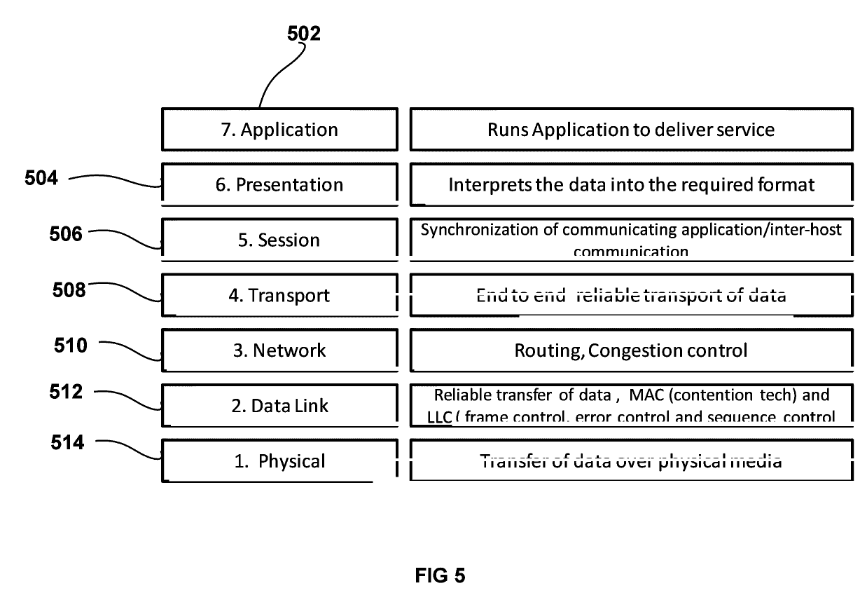

FIG. 3, FIG. 4 and FIG. 5 form the underlying principle of the invention and in further drawings along with description, the invention is elaborated including the architecture of the invention. The control equipment for multiple disparate infrastructures that were earlier used for delivery of utility services, now terminates at the aggregation equipment (refer to FIG. 2).

Now, referring to FIG. 3, is illustrated a simplified schematic diagram of Aggregation Equipment 202, wherein all the various service providers terminate their service feed. As evident from FIG. 3, feed of various service providers providing a plurality of services including, but not limited to, building Management System 302 (security and surveillance), multiple Triple Play 304 (voice, video and data), plurality of Head-end in the sky (HIT) 306, Direct to Home (DTH) 308, GSM/CDMA based services 310, are accommodated in the aggregator equipment 312. It may also be noted by a person ordinary skilled in the art that triple play 304 services are carried over VC/VLAN (Circuit/Local Area Network) over designated wavelength whereas all the other services 306, 308 and 310 are carried over predetermined designated wavelength. A single fiber optic media 320 carries services 302, 304, 306, 308 and 310 of multiple service providers terminated at the aggregator equipment 312 to their respective service seekers or subscribers. An service seeker end point equipment (ONU) implementated at the service seeker or subscriber side has multiple discrete ports that are allocated to the respective service provider as per their choice. Further, the single secure optical fiber 320 is configured to aggregate multiple service IP packets received via plurality of programmable service-provider side interface units and configured to deliver the service IP packets to designated destinations via the programmable subscriber side interface unit. Also, the single secure optical fiber 320 has a plurality of secure tunnels dedicated separately to each of the plurality of service providers and each of the secure tunnels having plurality of programmable circuits capable of transmitting distinct service IP packets to the respective subscribers.

Thus, Aggregation equipment 312 is used to aggregate varied services including Building Management Services, Security and Surveillance 302, voice, video, data, Triple Play service 304, DTH—Direct to Home 308, HITS—Headend in the sky 306, 3G, Wimax, GSM/CDMA 310 from multiple service providers and also services like local video on demand, Cable Television, Automated Meter Reading, Home Automation, Remote Home Monitoring, Remote Access and other IP based services for utility application. In accordance with various embodiments of the present invention all of the above mentioned services now are provisioned over single physical optical fiber media.

With respect to IP packet based communication technology, the invention as per FIGS. 3, 4, 5, 6, 7, 8, 9, 10, 11, and 12, is a system of segregating the physical communication media more particularly a lit fiber into multiple logical media within the lit fiber, each capable of carrying varied IP services. The logical media is created over the physical media as a circuit/VLAN/Pseudowire for respective service providers and the estate owner. The progressive sequence of drawing clearly elaborates how the IP based services are configured using the present invention where the infrastructure acts merely as a neutral network without entering into the service domain of a service provider.

Referring to FIG. 4, there is illustrated a simplified block diagram of Neutral Access Network for IP based Services with first sequence. As known in the art, an OSI/ISO architecture has seven major layers namely, physical layer 402, Data link layer 404, network layer 406, transport layer 408, session layer 410, presentation layer 412 and application layer 414. The secure single lit optical fiber as disclosed in our invention, primarily uses physical layer 402, Data link layer 404, for its configuration and operations while all other layers 406, 408, 410, 412 and 414 are used by service providers for service delivery and provisioning purposes. The physical layer 402 comprises of a single fiber media carrying all the services by the service provider. As evident from FIG. 4, the conventional systems used multiple discrete infrastructure for provisioning plurality of services from distinct service providers or plurality of services from same service provider from User premises 416 to Service room 418 or vice versa. This resulted in wasteful use of infrastructure and depletion of resources. The Data link layer 404 comprises of logical segregation in the tunnel through circuit, VLAN, Pseudo wire in the secure single lit optical fiber. To maintain the integrity of the service being delivered by a service provider and maintain transparency of the infrastructure between the service provider and subscribers, tunnels are created at Data link layer 404, such that service delivery parameters (Quality Of Service Parameters) of a service provider is not altered. As evident, using the secure single lit fiber, communication between User premises 420 (having an ONU) and service room 422 (having OLT) uses only a single fiber and thus avoids wasteful uses of resources.

FIG. 5 is simplified block diagram of a Neutral Access Network for IP based Services. The multiple OSI/ISO layers depicted in FIG. 5 have the common use across telecommunication industry by the Service Providers/Operators. At physical layer 512, transfer of data takes place over physical media. As, explained in the description of in FIG. 4, logical segregation takes place at the data link layer 512. Improvements bought by the present invention at the logical layer 512 makes transfer of data secure and reliable. At network layer 510, routing and congestion control takes place while the transport layer 508, enables end-to end reliable transport. Further, session layer 506 helps in synchronization of communicating application and inter-host communication. Presentation layer 504 interprets the data in desired format and application layer 502 helps in delivering services at the user end. In other words specific to the requirements of the present invention, FIG. 5 describes transfer of data over secure single lit fiber media from the Physical layer 514 to the Application layer 502 using the logical segregation at Data Link 512 there by routing and congestion control for the multiple Service Providers at the Network Layer 510 and transmit the same to the Transport layer 508.

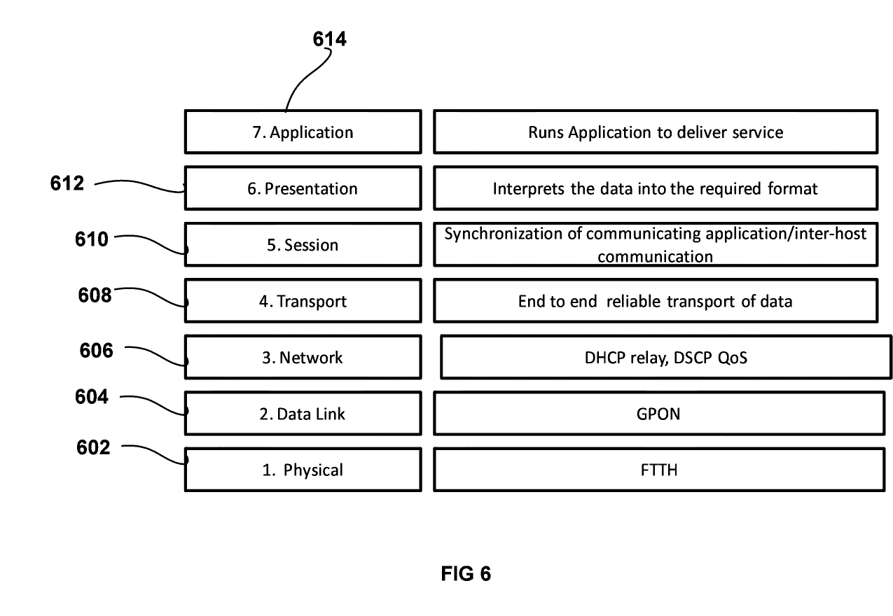

FIG. 6 is simplified block diagram of a Neutral Access Network for IP based Services with a third sequence and describes that the secure single lit fiber is used as a medium for the Physical Layer 602. At Data Link Layer 604, X-PON technology is being used and on the Network layer 606 various network features i.e. DHCP relay, DSCP, Qos are being used. Layers 608, 610, 612 and 614 have their usual workings

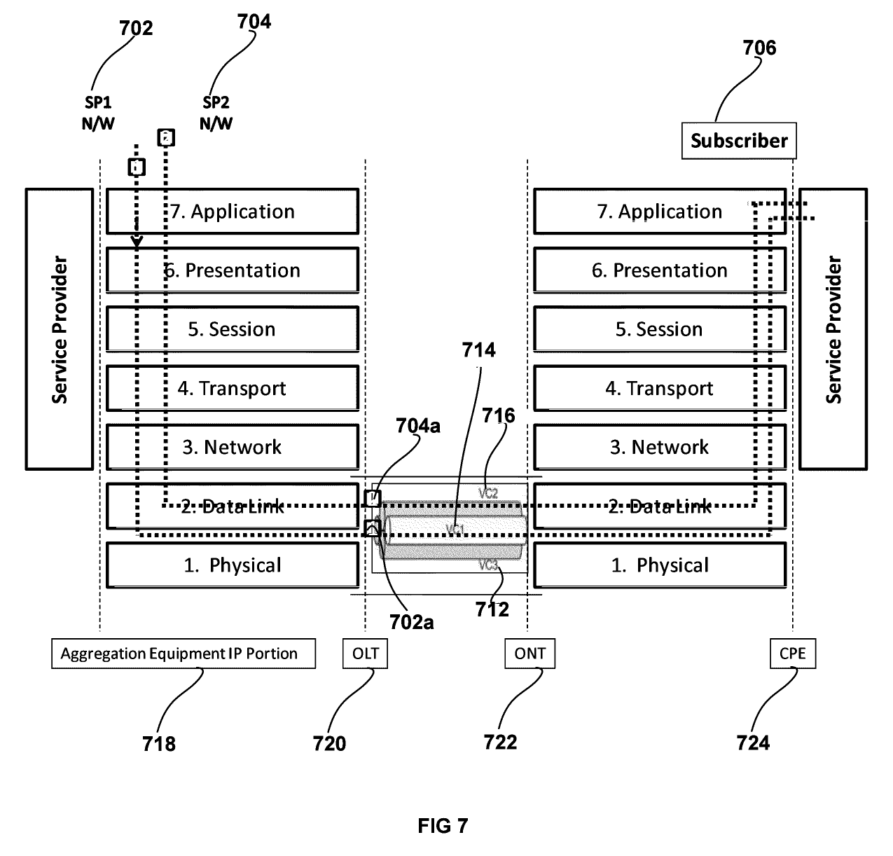

Referring to FIG. 7 is illustrated a simplified block diagram of a Neutral Access Network for IP based Services with a fourth sequence and depicts how plurality of Service Providers 702 and 704 using the several layers of the Single lit Optic Fiber can reach the end Subscriber 706 and terminate at their Premises Equipment 724 through the Circuits 712, 714 and 716 created in the tunnel 702a and 704a at the Data link layer 710 of the Optic Fiber using the OLT 720 and ONU 722 interface and a logical segregation at the Data Link layer 710. The creation of Circuits 712, 714 and 716 within the tunnels 702a and 704a forms the core of the invention. Also, each of the plurality of secure tunnels dedicated separately to each of the plurality of service providers and each of the secure tunnels 702a and 704a having plurality of programmable circuits 712, 714 and 716 is capable of transmitting distinct service IP packets to the respective subscribers. Further, optical fiber receives plurality of services from the aggregator 718 and transmits them through multiple inbuilt service provider specific secure circuits 712, 714 and 716 such that each of the plurality of service provider 702 and 704 has a dedicated secure circuit 702a and 704a for rendering the plurality of services such that service provider 702 is unaware of existence of service provider 704 and vice versa. Further, each service provider 702 and 704 is unaware of existence of secure circuits dedicated to other services providers.

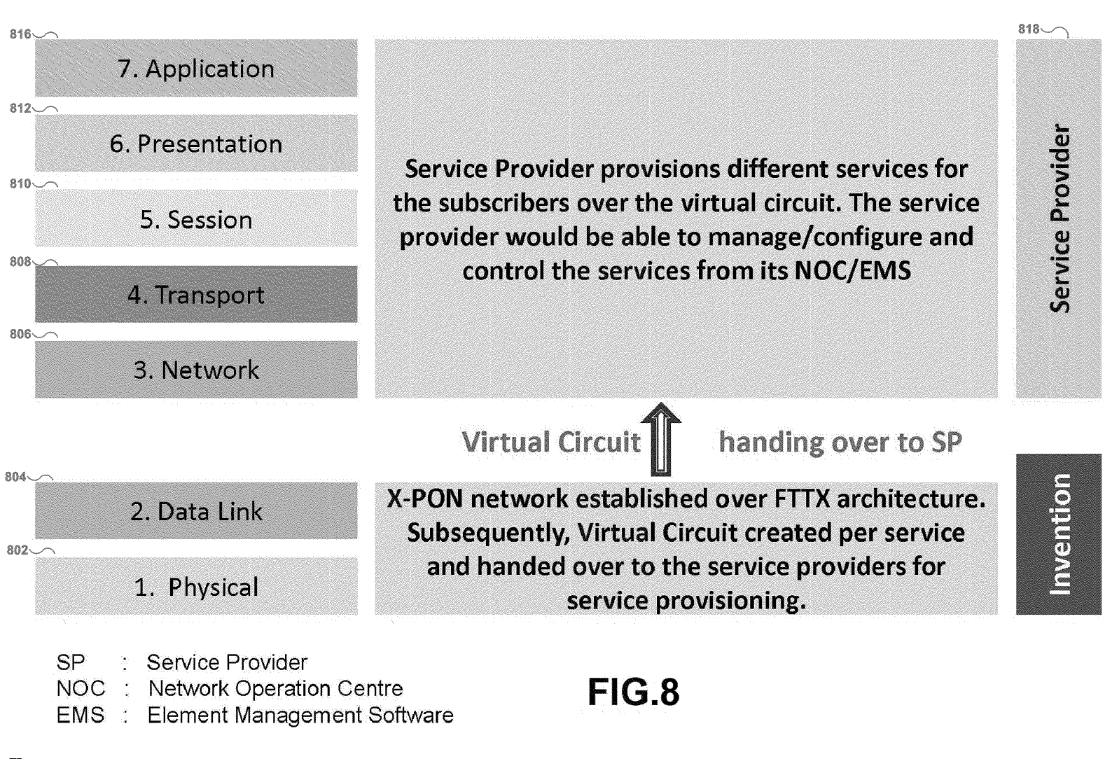

Referring to FIG. 8 is a simplified block diagram of a Neutral Access Network for IP based Services with a fifth sequence. Once the tunnels are created at the data link layer 804, the same is handed over to the respective service providers 818. The tunnels created are secure and maintains ownership of the network resources for the service providers 818. From the Network Layer 806, Service provider 818 provisions different services for the subscriber over the Circuit so created. The Service provider would also be able to manage/configure and control the services from its NOC (network operation center) and/or EMS (element management software)

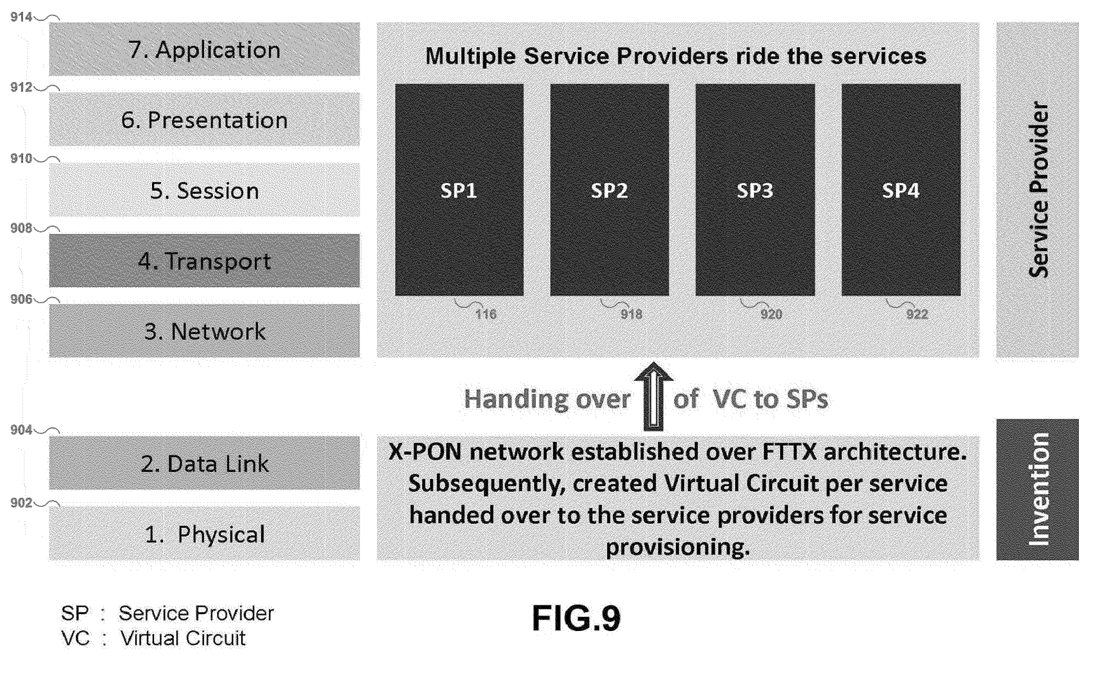

FIG. 9 is simplified block diagram of a Neutral Access Network for IP based Services with a sixth sequence. The tunnels created over physical layer 902 and data link layer 904 and are handed over to the service providers 916, 918, 920 and 922 are secure such that circuit of one service provider does not interfere/affects the circuit of the other. Each circuit has a unique identity and is allocated to the service provider with required accessibility to it. The service providers 916, 918, 920 and 922 can then get complete control of network layer 906, transport layer 908, session layer 910, presentation layer 912 and application layer 914.

In the present invention, to accommodate IP based services by various service providers, a single physical media fiber (dark) is laid, i.e. Layer-1, Moving up, at layer 2 logical separation (dark fiber) is created for respective service provider. The logical separations happen in the present invention such that the relationship between the service provider and their subscribers are intact. Multiple IP Services from multiple service providers are provisioned over a single physical media occupying a pair of wavelengths (two wavelengths) one for upstream, another for downstream and other RF based services are provisioned over subsequent wavelengths.

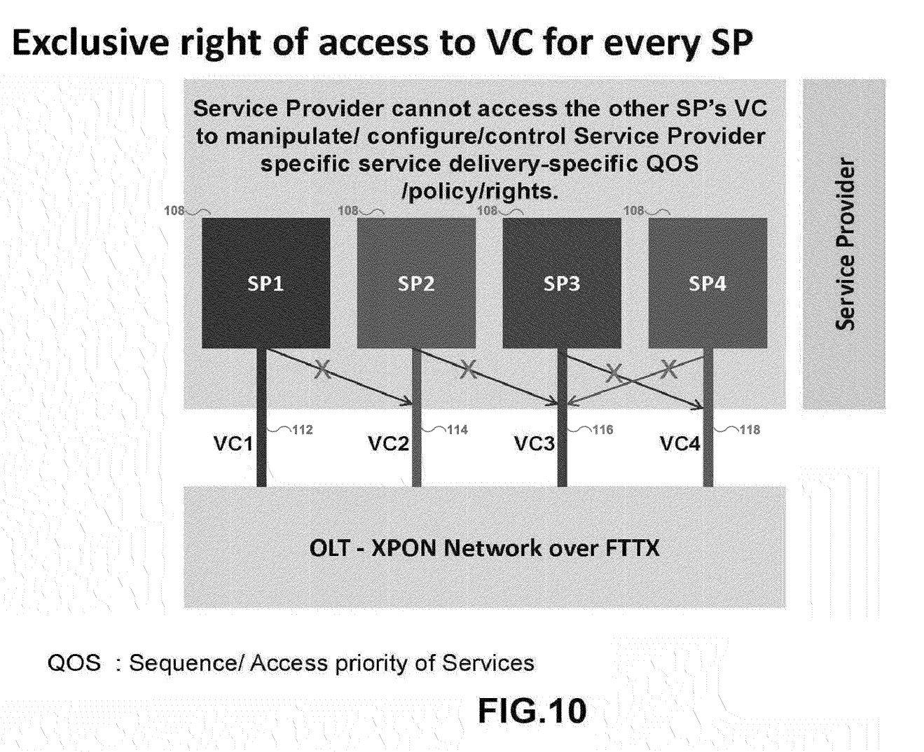

The foregoing approach becomes more evident from a further description of the figures. Referring to FIG. 10 is a simplified block diagram of a Neutral Access Network for IP based Services with a seventh sequence and depicts the security and exclusivity aspect of the inventions. As evident, any one of the plurality of service providers 120, 122, 124 and 126 cannot Access the Circuit 112, 114, 116 and 118 of any other Service Provider, who is riding on the same fiber and thus there can be no manipulation, configuration, control on the Service Provider 120, 122, 124 and 126 specifics by any other Service Provider 120, 122, 124 and 126, and any such specifics do not alter/modify the Quality offered to one Service Provider 120, 122, 124 and 126 or the respective policy rights.

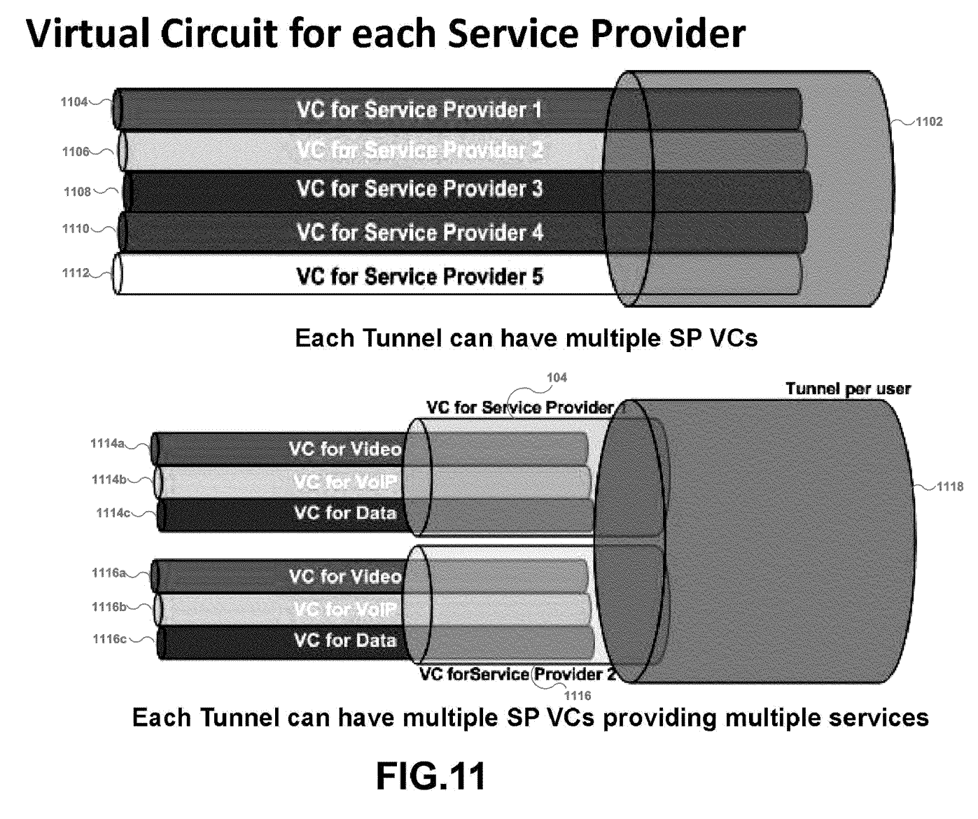

FIG. 11 is a simplified block diagram of a Neutral Access Network for IP based Services with an eighth sequence and describes that each Tunnel 1102 and 1118 as created can have multiple Service Providers 1104, 1106, 1108, 1110 and 1112 providing multiple services through multiple circuits created within the dedicated tunnels 1102 and 1118. Further, as evident circuits 1114a, 1114b and 1114c are dedicated for Service provider 1114 and 1116a, 1116b and 1116c are dedicated for Service provider 1116. Also, both dedicated tunnels for service providers 1114 and 1116 are part of single user tunnel 1118. It is also evident from the FIG. 11 that service provider specific secure tunnels of service provider 1114 and 1116 have dedicated secure circuit 1114a, 1114b, 1114c and 1116a, 1116b, 1116c respectively for rendering the plurality of services such that each of the service providers 1114 and 1116 is unaware of existence of any other service provider. Further, each service provider 1114 and 1116 is unaware of existence of secure circuits dedicated to other services providers.

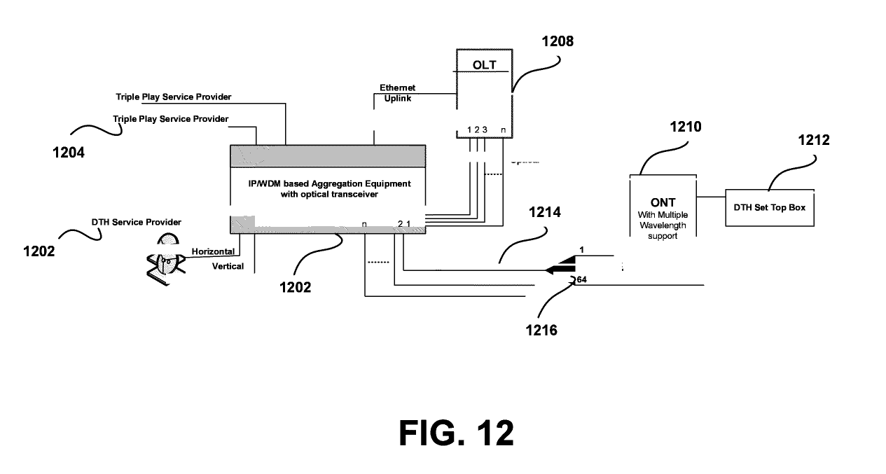

FIG. 12 is a block diagram of a Neutral Access Network for RF based DTH/HITS/CATV Services—Sequence 1 and illustrates implementation of the radio frequency based DTH 1202 and triple play services 1204 Services. Multiple RF based services are terminated at IP/WDM based aggregation equipment 1206 with Optical transmitter 1208. The aggregation equipment 1206 is connected carrying the plurality of services provided by multiple Service providers 1202 and 1204 with a single fiber optic media 1214. This single fiber optic media 1214 is connected to a splitter 1216 for the distribution to multiple ONUs 1210. ONU 1210 is capable of Multiple Wavelength support. From ONU 1210 the connectivity is provided to the DTH Set top Box 1212. The service providers are allocated respective wavelengths for carrying of services.

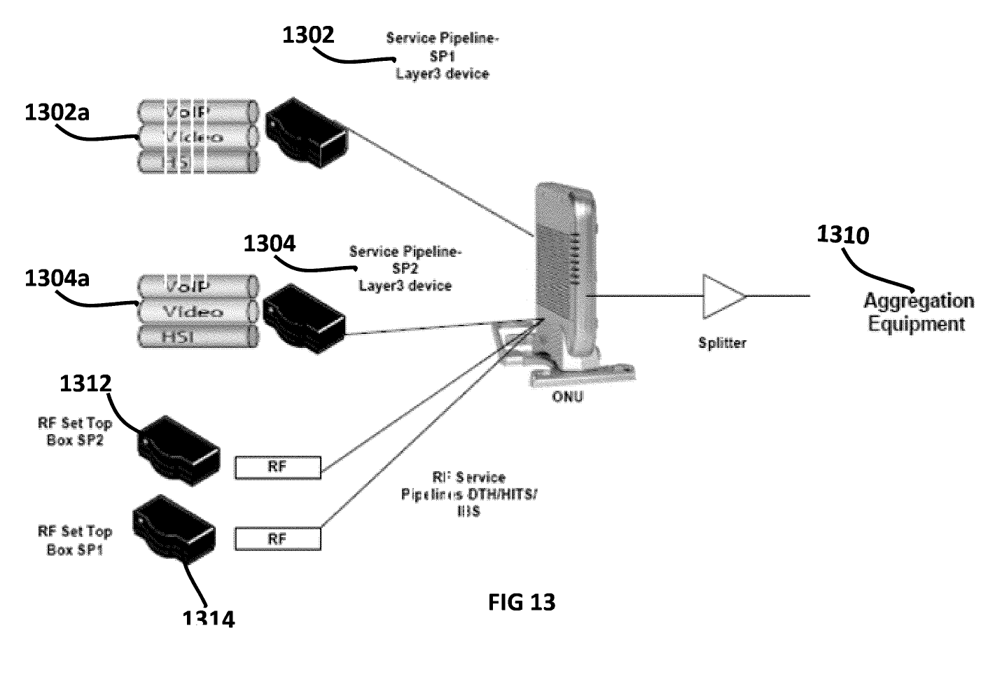

FIG. 13 is a block diagram of Neutral Access Network for RF based DTH/HITS/CATV Services—Sequence 2 and shows a plurality of services 1302a and 1304a associated with plurality of service providers 1302 and 1304. Also shown is a splitter 1308 connected with aggregation equipment 1310. Further, FIG. 13 depicts multiple Service Providers 1302 and 1304 offering multiple services 1302a and 1304a to the subscribers both IP and RF type. At the ONU 1306, subscriber may choose the preferred service provider amongst available multiple service provider 1302 and 1304. On the basis of choice, RF services 1302a and 1304a can be delivered by the preferred service provider by decoupling the optical signal of the wavelength assigned to the service provider 1302 and 1304. In case of IP services, the ports can be assigned to multiple service providers 1302 and 1304 for services. It may also be noted that, the service delivery tunnel of a service provider 1302 and 1304 created at the aggregation equipment 1310 terminates at the network layer device or layer 3 device specific to 1302 and 1304. For service provisioning, a computer programmable equipment (CPE) is plugged into the port of the end point. The network layer device needs to have IP address for service provisioning that could be acquired automatically through DHCP. Further, it may also be note that each of the RF set up box 1312 and 1314 dedicated to service providers 1302 and 1304 has default values configured in it for automatic provisioning.

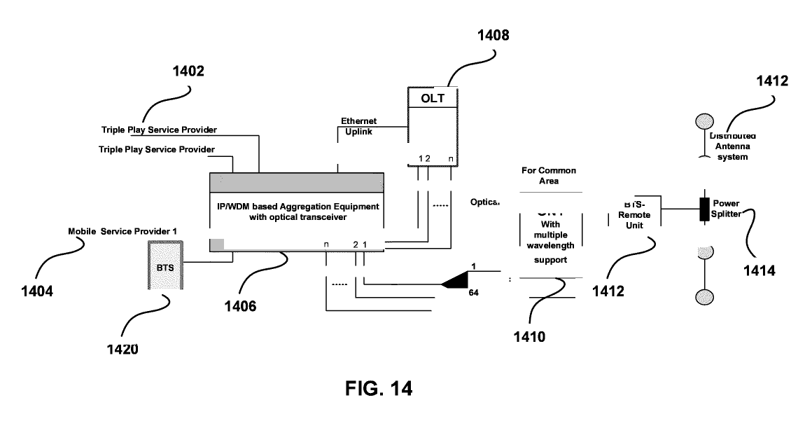

Referring now to FIG. 14 is illustrated a block diagram of a Neutral Access Network for GSM/CDMA/Mobile Services through a Distributed Antenna System. The figure shows multiple service providers 1402 and 1404 offering multiple services (GSM/CDMA/Mobile Services) to the subscribers on the RF basis. BTS Tower (Base Transceiver System) 1420 of the Service Providers 1402 and 1404 is connected to the Aggregate equipment 1406 and at the ONU 1410 the Radio frequency based mobile service can be split basis the wavelength requirement of an individual Service Provider, which in turn is further linked with another BTS Remote unit 1412. This BTS remote Unit 1412 is then linked to the Power Splitter 1414 which in turn is linked to Distributed Antenna system 1412, which provides the last mile connectivity to the subscriber of the services.

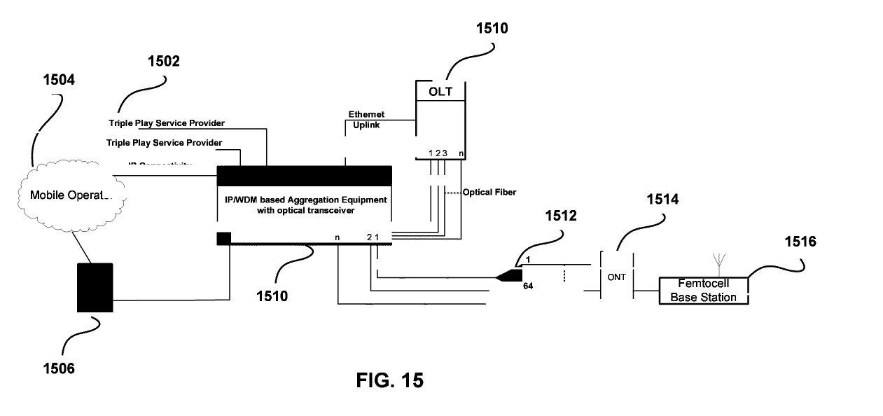

FIG. 15 is a block diagram of a Femtocell based System in a Building Solution and shows Multiple Service Providers 1502 and 1504 offering multiple services (GSM/CDMA/Mobile Services) to the subscribers on the IP basis. BTS Tower 1506 (Base Transceiver System) of the Service Provider 1502 and 1506 is connected to the Aggregate equipment using single lit optic fiber. At the Aggregate equipment 1508 the RF based transmitted data is converted into IP based through the Optical transceiver 1510, which then is transmitted to the ONU 1514. At the ONU 1514, the fiber is extended up to the femtocell 1516 base station where on the optical fiber, circuits are created for each service of the Service Providers 1502 and 1504.

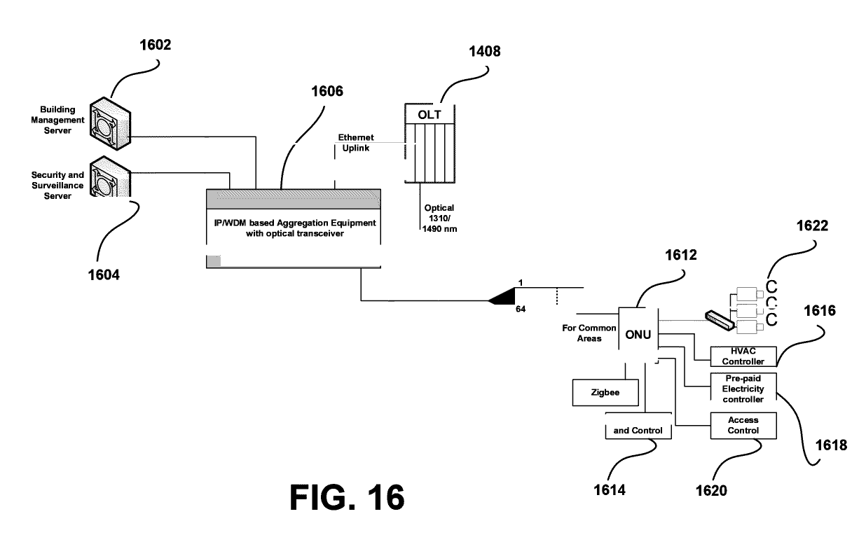

FIG. 16 is an exemplary diagram of the preferred embodiment of the invention and shows the complete infrastructure for the Building Management Services and Security and Surveillance Server 1602 and 1604 connected with the aggregating equipment 1606 which is connected to the ONU 1612 through a single lit optic fiber. From the ONU 1612 the services are delivered to end subscriber at 1622. Also coupled to ONU are various control means like Automation and control equipment 1614, access control equipment 1620, HVAC controller 1616, Electricity controller 1618 etc.

As evident in FIGS. 2, 3, 4, 15 and 16, segregation of multiple RF based services is achieved by WDM Coupler at Aggregation Equipment. Each service is provisioned over a wavelength. WDM Coupler carries multiple RF based services on multiple wavelengths with each RF service provisioned over a separate wavelength. These multiple wavelengths are then decoded at the user end and the delivery of service happens through the ONU. It supports multiple wavelength channels through which multiple services from multiple service providers is provisioned. Through use of Element Management software, the RF port of the ONU is administered to decouple the desired RF service chosen by the end-user. The fiber architecture designed for the invention is a point to point or point to multipoint network in which the fiber components recommended between Utility room and each home is passive in nature to have more reliability and ease of deployment, although any active component can also be used as optical amplifier or repeater, forward or reverse path wavelengths injector. The fiber component that is used to cater multiple end-users with a single fiber is an optical splitter. The same optical splitter can cater to several other establishments in the vicinity. Each output fiber strand of the splitter reaches to each end-user with few fibers dedicated to common areas for utility services.

Further, as evident in FIGS. 2, 12, 15 and 16 in each user unit (e.g., home), ONU is connected to the Fiber entering the user unit to enable the gamut of services riding over the fiber. Each ONU is capable of delivering IP based and RF based services inside the user-unit. The services from the respective service provider distributed over a wavelength from the OLT reaches to the ONU and is undistributed through the respective service provider's end equipment or residential gateway (RG). The service provider RG is a network layer device capable of decoding the services encapsulated in the VLAN/VC/Pseudowire and delivering them to the user equipment like STB, TV, Laptop, Telephone. The ONU enables the delivery of TDM services, and wireless mobility including GSM/CDMA/WiFI and home automation on Zigbee, also.

Furthermore, an ONU is dedicated for common areas to deliver utility services like Building Management services, Prepaid electricity, security and surveillance, GSM/CDMA/Wifi, Announcement system and various other control systems. The end equipments for the above mentioned services are connected to the ONU that establishes communication to their respective servers for control, management and configuration. To strengthen the In building Mobility service-GSM/CDMA Distributed Antennae are also connected to the ONU. To provide better manageability, control and to the smoothen the provisioning of the services by multiple service provider, a network layer management software is implemented to have better visibility in the operation, monitoring, and provisioning of the services by the respective service provider. The management software provides additional layer of manageability such that the administrator can manage, control and monitor the ONT-CPE, its service related and service provider related information. In order to provision IP based service, an administrator assigns the port of the ONT to the VLAN/VC/Pseudowire Identification of the specific service provider.

The administrator controls and enables any one wavelength channel out of all the available channels to the ONT RF port; in order to provision RF based service-DTH/IBS/HITS/CATV. A restricted access of the network visibility is given to the respective service provider for monitoring purposes such that only its subscriber information is visible. This enables transparency of operation and service provisioning between user and service provider.

While this invention has been described with the exemplary embodiments outlined above, to solve the most critical technical problem of a project, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of this invention in future. Therefore, the invention is intended to embrace all known or later-developed alternatives, variations, improvements and/or substantial equivalents related to the integrated infrastructure.

1-12. (canceled)

13. A community based communication system (200) for providing a plurality of services (136, 138) rendered by a plurality of service providers (106, 108) to a plurality of occupants of the community, said system comprising:
an aggregator (202a) to aggregate said plurality of services (136, 138) from said plurality of services providers (106, 108);
a splitter (206) to distribute said plurality of services for said plurality of occupants of the community;
an optical fiber (210a) connecting said aggregator (202a) to said splitter (206);
wherein said optical fiber (210a) receives said plurality of services from said aggregator (202a) and transmits the received plurality of services to said splitter (206) through multiple inbuilt service provider specific secure tunnels in such manner that each of the said plurality of service providers (106, 108) has a dedicated secure tunnel (702a) for rendering each of said plurality of services and where each dedicated secure tunnel is unaware of existence of other secure tunnels dedicated to other of said services providers (106, 108);
wherein said dedicated secure tunnels (702a), as associated with each of said plurality of service providers (106, 108), are configured to have multiple circuits (712) for transmitting said plurality of services to their corresponding plurality of occupants of the community.

14. A communication system for providing multiple IP service packets to a destination via a secure optical fiber (210a), said system comprising:
an infrastructure of multiple service providers (702, 704) providing multiple service IP packets to a plurality of destinations (706), each destination having a programmable occupant-side interface unit (724) connected to a plurality of programmable service provider-side interface units (720, 722) via a single secure optical fiber (210a), said single secure optical fiber (210a) configured to aggregate multiple service IP packets received from the infrastructure via a plurality of programmable service-provider side interface units (720, 722) and configured to deliver the service IP packets to designated destinations (706) via the programmable occupant-side interface unit (724),
wherein the single secure optical fiber (210a) has a plurality of secure tunnels (702a, 704a) dedicated separately to each of said plurality of service providers (702, 704) and wherein each of said secure tunnels (702a, 704a) comprise a plurality of programmable circuits (712, 714) capable of transmitting distinct service IP packets.

15. An integrated communication infrastructure system for transporting a plurality of civil management services provided by a plurality of service providers to a plurality of end users, the system comprising:
aggregation equipment for aggregating the plurality of civil management services provided by the plurality of said service providers;
a service delivery port implemented at each of the plurality of end users; and
an optic fiber originating from said aggregation equipment and terminating at said service delivery port, said optic fiber configured to create a plurality of secured mediums such that each of said secured mediums is connected to at least one of said delivery ports for to and from transport of the plurality of the civil management services provided by at least one of said plurality of service providers,
wherein each of said secured mediums is such programmed that each of the service providers is capable to manage, configure and administer their respective services independently of other service providers.

16. The system as claimed in claim 15, wherein said civil management services comprise at least one member selected from a group consisting of building management services, building automation services, security services, surveillance services, home automation and remote management services, services implemented on wire-line and wireless services of voice video and data, service based on either internet Protocol (IP) or service based on Radio Frequency (RF).

17. The system as claimed in claim 16, wherein said civil management services are implemented on one or more of wire-line or wireless services of voice, video and data.

18. The system as claimed in claim 15, wherein said civil management services comprise at least one member selected from a group consisting of billing information, information gathering, information sharing, audio broadcast, video broadcast wherein each selected member comprises a service based at least in part on an Internet Protocol (IP), Time Division Multiplexing (TDM), Asynchronous Transfer Mode (ATM), Voice over IP (VoIP) or Radio Frequency (RF).

19. The system as claimed in claim 15, wherein each of the plurality of said multiple service providers manages, configures and administers their respective services independent of other service providers.

20. A multi-play single fiber system comprising:
a single fiber for provisioning at least one member selected from a group consisting of Global System of Mobile (GSM) Communication, Code Division Multiple Access (CDMA), Worldwide Interoperability for Microwave Access (Wimax) and Global Positioning System (GPS) wherein each selected member comprises a service implemented on one or more of an Asynchronous Transfer Mode (ATM), Time-Division Multiplexing (TDM), Transmission Control Protocol-Internet Protocol (TCP-IP), Radio Frequency (RF), Wavelength Division Multiplexing (WDM) or Dense Wavelength Division Multiplexing (SWDM); and
a hardware coupled computer programmable device coupled with the single fiber to create a plurality of tunnels within said single fiber and create a plurality of circuits within said tunnels.
